(19) United States
(12) Patent Application Publication
(10) Pub. No.: US 2016/0020916 A1
(43) Pub. Date: Jan. 21, 2016

(54) SERVICE INDICATION PROCESSING METHOD AND APPARATUS

(71) Applicant: Huawei Technologies Co., Ltd., Shenzhen (CN)

(72) Inventors: Junhui Zhao, Shenzhen (CN); Zhenxing Hu, Shenzhen (CN); Wei Quan, Beijing (CN); Pengyu Ji, Shenzhen (CN); Jian Zhang, Beijing (CN); Qinghai Zeng, Shanghai (CN); Mingzeng Dai, Shanghai (CN)

(21) Appl. No.: 14/871,579

(22) Filed: Sep. 30, 2015

Related U.S. Application Data
(63) Continuation of application No. PCT/CN2013/073734, filed on Apr. 3, 2013.

(51) Int. Cl. H04L 12/18; H04W 72/00; H04W 4/06

(52) U.S. Cl. CPC H04L 12/189; H04W 4/06; H04W 72/005; H04W 88/08

(57) ABSTRACT

Embodiments of the present invention provide a service indication processing method and an apparatus, where the method includes: receiving, by user equipment UE, a system message sent by a base station corresponding to a legacy carrier type LCT cell, where the system message includes information about a new carrier type NCT frequency and information that is about a service area identity of a multimedia broadcast multicast service MBMS SAI and corresponds to the information about the NCT frequency; and performing, by the UE according to the system message, indication processing on an MBMS service that is being received or of interest. The technical solutions of the present invention can ensure continuity of receiving, by the UE, an MBMS service of an NCT cell.

### CROSS-REFERENCE TO RELATED APPLICATIONS

This application is a continuation of International Application No. PCT/CN2013/073734, filed on Apr. 3, 2013, which is hereby incorporated by reference in its entirety.

### TECHNICAL FIELD

Embodiments of the present invention relate to communications technologies, and in particular, to a service indication processing method and an apparatus.

### BACKGROUND

A multimedia broadcast multicast service (Multimedia Broadcast Multicast Service, MBMS for short) is introduced in the fourth generation mobile telecommunications system such as release 10 of a long term evolution (LTE) system of Release 10 (Long Term Evolution Release 10, LTE R10 for short) and is enhanced in R10 and R11 separately. The MBMS supports two modes: a multimedia broadcast service and a multimedia multicast service, where multimedia video information may be broadcast directly to all users, or may be sent to a group of paying subscribers for watching, which may help an operator deploy multiple commercial applications such as multimedia advertising, free or paid television channels, and multimedia group messaging, so that the operator can deploy mobile phone television services at lower network deployment costs.

In the prior art, a smallest coverage unit of the MBMS is a cellular cell of a legacy carrier type (LCT), which can provide users at different locations with rich services. Because each cell of a cellular network has a relative small coverage range and more precise network planning, different content can be broadcast separately in different areas of the network. However, a new carrier type (NOT) cell is introduced in the existing LTE R12, and continuity of receiving, by user equipment (UE), an MBMS service of an NOT cell cannot be ensured.

### SUMMARY

Embodiments of the present invention provide a service indication processing method and an apparatus, which are used to ensure continuity of receiving, by UE, an MBMS service of an NCT cell.

According to a first aspect of the present invention, a service indication processing method is provided, including:

receiving, by user equipment UE, a system message sent by a base station corresponding to a legacy carrier type LCT cell, where the system message includes info nation about a new carrier type NCT frequency and information that is about a service area identity of a multimedia broadcast multicast service MBMS SAI and corresponds to the information about the NCT frequency; and

performing, by the UE according to the system message, indication processing on an MBMS service that is being received or of interest.

In a first possible implementation manner of the first aspect, the system message further includes at least one type of the following information:

identity information of an NCT cell;

an LCT frequency that provides assistance for the NOT cell or the NOT frequency in supporting the MBMS service; and

identity information of an LCT cell that provides assistance for the NCT cell or the NCT frequency in supporting the MBMS service.

With reference to the first aspect or the first possible implementation manner of the first aspect, in a second possible implementation manner of the first aspect, resources of the NCT frequency are all used to support the MBMS and the system message further includes resource indication information or resource configuration information.

According to the second possible implementation manner of the first aspect, in a third possible implementation manner of the first aspect, the resource indication information includes at least one type of the following information:

an indication of supporting multiple-input multiple-output;

an indication of supporting a reference signal; and

an indication of supporting a transfer mode; and

the resource configuration information includes at least one type of the following information:

a configuration of multiple-input multiple-output;

a configuration of a reference signal; and

a configuration of a transfer mode.

With reference to the first aspect or any one of the first to the third possible implementation manners of the first aspect, in a fourth possible implementation manner of the first aspect, a frequency corresponding to the MBMS service that is being received or of interest is an NCT frequency; and

the performing, by the UE according to the system message, indication processing on an MBMS service that is being received or of interest includes:

setting, by the UE in idle state according to the system message, the NCT frequency to a highest priority for cell selection or reselection performed by the UE; or

setting, by the UE in idle state according to the system message, the LCT frequency to a highest priority for cell selection or reselection performed by the UE, where the LCT frequency provides assistance for the NCT frequency in supporting the MBMS service; or

setting, by the UE in idle state according to the system message, the NCT frequency and the LCT frequency to a highest priority for cell selection or reselection performed by the UE, where the LCT frequency provides assistance for the NCT frequency in supporting the MBMS service.

With reference to the first aspect or any one of the first to the third possible implementation manners of the first aspect, in a fifth possible implementation manner of the first aspect, a frequency corresponding to the MBMS service that is being received or of interest is an NCT frequency; and

the performing, by the UE according to the system message, indication processing on an MBMS service that is being received or of interest includes:

sending, by the UE in connected state according to the system message, MBMS indication information to the base station corresponding to the LCT cell, where the MBMS indication information includes the NCT frequency.

According to a second aspect of the present invention, a service indication processing method is provided, including:

generating, by a base station corresponding to a legacy carrier type LCT cell, a system message, where the system message includes information about a new carrier type NCT frequency and information that is about a service area identity of a multimedia broadcast multicast service MBMS SAI and corresponds to the information about the NCT frequency; and

sending, by the base station corresponding to the LCT cell, the system message to user equipment UE, so that the UE performs, according to the system message, indication processing on an MBMS service that is being received or of interest.

In a first possible implementation manner of the second aspect, the system message further includes at least one type of the following information:

identity information of an NCT cell;

an LCT frequency that provides assistance for the NCT cell or the NCT frequency in supporting the MBMS service; and

identity information of an LCT cell that provides assistance for the NCT cell or the NCT frequency in supporting the MBMS service.

With reference to the second aspect or the first possible implementation manner of the second aspect, in a second possible implementation manner of the second aspect, resources of the NCT frequency are all used to support the MBMS and the system message further includes resource indication information or resource configuration information.

According to the second possible implementation manner of the second aspect, in a third possible implementation manner of the second aspect, the resource indication information includes at least one type of the following information:

an indication of supporting multiple-input multiple-output;

an indication of supporting a reference signal; and

an indication of supporting a transfer mode; and

the resource configuration information includes at least one type of the following information:

a configuration of multiple-input multiple-output;

a configuration of a reference signal; and

a configuration of a transfer mode.

With reference to the second aspect or any one of the first to the third possible implementation manners of the second aspect, in a fourth possible implementation manner of the second aspect, a frequency corresponding to the MBMS service that is being received or of interest is an NCT frequency; and

the sending, by the base station corresponding to the LCT cell, the system message to user equipment UE, so that the UE performs, according to the system message, indication processing on an MBMS service that is being received or of interest includes: sending, by the base station corresponding to the LCT cell, the system message to the user equipment UE, so that the UE in idle state sets, according to the system message, the NCT frequency to a highest priority for cell selection or reselection performed by the UE; or

sending, by the base station corresponding to the LCT cell, the system message to the user equipment UE, so that the UE in idle state sets, according to the system message, the LCT frequency to a highest priority for cell selection or reselection performed by the UE, where the LCT frequency provides assistance for the NCT frequency in supporting the MBMS service; or

sending, by the base station corresponding to the LCT cell, the system message to the user equipment UE, so that the UE in idle state sets, according to the system message, the NCT frequency and the LCT frequency to a highest priority for cell selection or reselection performed by the UE, where the LCT frequency provides assistance for the NCT frequency in supporting the MBMS service.

With reference to the second aspect or any one of the first to the third possible implementation manners of the second aspect, in a fifth possible implementation manner of the second aspect, a frequency corresponding to the MBMS service that is being received or of interest is an NCT frequency; and

the sending, by the base station corresponding to the LCT cell, the system message to user equipment UE, so that the UE performs, according to the system message, indication processing on an MBMS service that is being received or of interest includes:

sending, by the base station corresponding to the LCT cell, the system message to the user equipment UE, so that the UE in connected state sends, according to the system message, MBMS indication information to the base station corresponding to the LCT cell, where the MBMS indication information includes the NCT frequency.

According to a third aspect of the present invention, user equipment is provided, including:

a receiving module, configured to receive a system message sent by a base station corresponding to a legacy carrier type LCT cell, where the system message includes information about a new carrier type NCT frequency and information that is about a service area identity of a multimedia broadcast multicast service MBMS SAI and corresponds to the information about the NCT frequency; and

a processing module, configured to perform, according to the system message, indication processing on an MBMS service that is being received or of interest.

In a first possible implementation manner of the third aspect, the system message further includes at least one type of the following information:

identity information of an NCT cell;

an LCT frequency that provides assistance for the NCT cell or the NCT frequency in supporting the MBMS service; and

identity information of an LCT cell that provides assistance for the NCT cell or the NCT frequency in supporting the MBMS service.

With reference to the third aspect or the first possible implementation manner of the third aspect, in a second possible implementation manner of the third aspect, resources of the NCT frequency are all used to support the MBMS and the system message further includes resource indication information or resource configuration information.

According to the second possible implementation manner of the third aspect, in a third possible implementation manner of the third aspect, the resource indication information includes at least one type of the following information:

an indication of supporting multiple-input multiple-output;

an indication of supporting a reference signal; and

an indication of supporting a transfer mode; and

the resource configuration information includes at least one type of the following information:

a configuration of multiple-input multiple-output;

a configuration of a reference signal; and

a configuration of a transfer mode.

With reference to the third aspect or any one of the first to the third possible implementation manners of the third aspect, in a fourth possible implementation manner of the third aspect, a frequency corresponding to the MBMS service that is being received or of interest is an NCT frequency; and

the processing module is specifically configured to:

set, according to the system message, the NCT frequency to a highest priority for cell selection or reselection performed by the UE; or

set, according to the system message, the LCT frequency to a highest priority for cell selection or reselection performed by the UE, where the LCT frequency provides assistance for the NCT frequency in supporting the MBMS service; or

set, according to the system message, the NCT frequency and the LOT frequency to a highest priority for cell selection or reselection performed by the UE, where the LCT frequency provides assistance for the NCT frequency in supporting the MBMS service.

With reference to the third aspect or any one of the first to the third possible implementation manners of the third aspect, in a fifth possible implementation manner of the third aspect, a frequency corresponding to the MBMS service that is being received or of interest is an NCT frequency; and

the processing module is specifically configured to:

send, according to the system message, MBMS indication information to the base station corresponding to the LCT cell, where the MBMS indication information includes the NCT frequency.

According to a fourth aspect of the present invention, abase station corresponding to a legacy carrier type is provided, including:

a generating module, configured to generate a system message, where the system message includes information about a new carrier type NCT frequency and information that is about a service area identity of a multimedia broadcast multicast service MBMS SAI and corresponds to the information about the NCT frequency; and

a sending module, configured to send the system message to user equipment UE, so that the UE performs, according to the system message, indication processing on an MBMS service that is being received or of interest.

In a first possible implementation manner of the fourth aspect, the system message further includes at least one type of the following information:

identity information of an NCT cell;

an LCT frequency that provides assistance for the NCT cell or the NCT frequency in supporting the MBMS service; and

identity information of an LCT cell that provides assistance for the NCT cell or the NCT frequency in supporting the MBMS service.

With reference to the fourth aspect or the first possible implementation manner of the fourth aspect, in a second possible implementation manner of the fourth aspect, resources of the NCT frequency are all used to support the MBMS, and the system message further includes resource indication information or resource configuration information.

According to the second possible implementation manner of the fourth aspect, in a third possible implementation manner of the fourth aspect, the resource indication information includes at least one type of the following information:

an indication of supporting multiple-input multiple-output;

an indication of supporting a reference signal; and

an indication of supporting a transfer mode; and

the resource configuration information includes at least one type of the following information:

a configuration of multiple-input multiple-output;

a configuration of a reference signal; and

a configuration of a transfer mode.

With reference to the fourth aspect or any one of the first to the third possible implementation manners of the fourth aspect, in a fourth possible implementation manner of the fourth aspect, a frequency corresponding to the MBMS service that is being received or of interest is an NCT frequency; and

the sending module is specifically configured to:

send the system message to the user equipment UE, so that the UE in idle state sets, according to the system message, the NCT frequency to a highest priority for cell selection or reselection performed by the UE; or

send the system message to the user equipment UE, so that the UE in idle state sets, according to the system message, the LCT frequency to a highest priority for cell selection or reselection performed by the UE, where the LCT frequency provides assistance for the NCT frequency in supporting the MBMS service; or

send the system message to the user equipment UE, so that the UE in idle state sets, according to the system message, the NCT frequency and the LCT frequency to a highest priority for cell selection or reselection performed by the UE, where the LCT frequency provides assistance for the NCT frequency in supporting the MBMS service.

With reference to the fourth aspect or any one of the first to the third possible implementation manners of the fourth aspect, in a fifth possible implementation manner of the fourth aspect, a frequency corresponding to the MBMS service that is being received or of interest is an NCT frequency; and

the sending module is specifically configured to:

send the system message to the user equipment UE, so that the UE in connected state sends, according to the system message, MBMS indication information to the base station corresponding to the LCT cell, where the MBMS indication information includes the NCT frequency.

According to a fifth aspect of the present invention, user equipment is provided, including a transmitter, a receiver, a memory, and a processor that is separately connected to the transmitter, the receiver, and the memory, where a set of program code is stored in the memory, and the processor is configured to invoke the program code stored in the memory to execute the method in the first aspect or any one of the possible implementation manners of the first aspect.

According to a sixth aspect of the present invention, a base station corresponding to a legacy carrier type cell is provided, including a transmitter, a receiver, a memory, and a processor that is separately connected to the transmitter, the receiver, and the memory, where a set of program code is stored in the memory, and the processor is configured to invoke the program code stored in the memory to execute the method in the second aspect or any one of the possible implementation manners of the second aspect.

According to the service indication processing method and the apparatus provided in the embodiments, UE receives a system message sent by a base station corresponding to an LCT cell, where the system message includes information about an NCT frequency and MBMS SAI information corresponding to the information about the NCT frequency, and the UE performs, according to the system message, indication processing on an MBMS service that is being received or of interest, so that continuity of receiving, by the UE, an MBMS service of an NCT cell can be ensured.

### BRIEF DESCRIPTION OF THE DRAWINGS

To describe the technical solutions in the embodiments of the present invention more clearly, the following briefly introduces the accompanying drawings required for describing the embodiments. Apparently, the accompanying drawings in the following description show some embodiments of the present invention, and persons of ordinary skill in the art may still derive other drawings from these accompanying drawings without creative efforts.

FIG. 1 is a flowchart of Embodiment 1 of a service indication processing method according to the present invention;

FIG. 2 is a flowchart of Embodiment 2 of a service indication processing method according to the present invention;

FIG. 3 is a flowchart of Embodiment 3 of a service indication processing method according to the present invention;

FIG. 4 is a flowchart of Embodiment 4 of a service indication processing method according to the present invention;

FIG. 5 is a flowchart of Embodiment 5 of a service indication processing method according to the present invention;

FIG. 6 is a flowchart of Embodiment 6 of a service indication processing method according to the present invention;

FIG. 7 is a flowchart of Embodiment 1 of a method for service counting in a new carrier type cell according to the present invention;

FIG. 8 is a flowchart of Embodiment 2 of a method for service counting in a new carrier type cell according to the present invention;

FIG. 9 is a flowchart of Embodiment 3 of a method for service counting in a new carrier type cell according to the present invention;

FIG. 10 is a flowchart of Embodiment 4 of a method for service counting in a new carrier type cell according to the present invention;

FIG. 11 is a flowchart of Embodiment 1 of user equipment according to the present invention;

FIG. 12 is a schematic structural diagram of Embodiment 2 of user equipment according to the present invention;

FIG. 13 is a schematic structural diagram of Embodiment 1 of a base station corresponding to a legacy carrier type according to the present invention; and

FIG. 14 is a schematic structural diagram of Embodiment 2 of a base station corresponding to a legacy carrier type cell according to the present invention.

### DETAILED DESCRIPTION

To make the objectives, technical solutions, and advantages of the embodiments of the present invention clearer, the following clearly describes the technical solutions in the embodiments of the present invention with reference to the accompanying drawings in the embodiments of the present invention. Apparently, the described embodiments are some but not all of the embodiments of the present invention. All other embodiments obtained by persons of ordinary skill in the art based on the embodiments of the present invention without creative efforts shall fall within the protection scope of the present invention.

The technical solutions provided in the present invention relate to an LTE system, and further relate to an LTE system in which an NCT cell or an NCT frequency is introduced in an access network. The NCT cell or the NCT frequency cannot work independently, that is, the NCT cell or the NCT frequency needs to rely on an existing non-NCT LCT cell or LCT frequency. Multiple NCT cells or NCT frequencies may be configured for one LCT cell or one LCT frequency. The present invention is applicable to a scenario in which a base station corresponding to an LCT cell sends, to UE, information about an NCT frequency supporting an MBMS and information that is about a service area identity of a multimedia broadcast multicast service (MBMS Service Area Identity, MBMS SAI for short) and corresponds to the information about the NCT frequency, so that the UE performs, according to a system message, indication processing on an MBMS service that is being received or of interest, thereby ensuring continuity of receiving an MBMS service of an NCT cell.

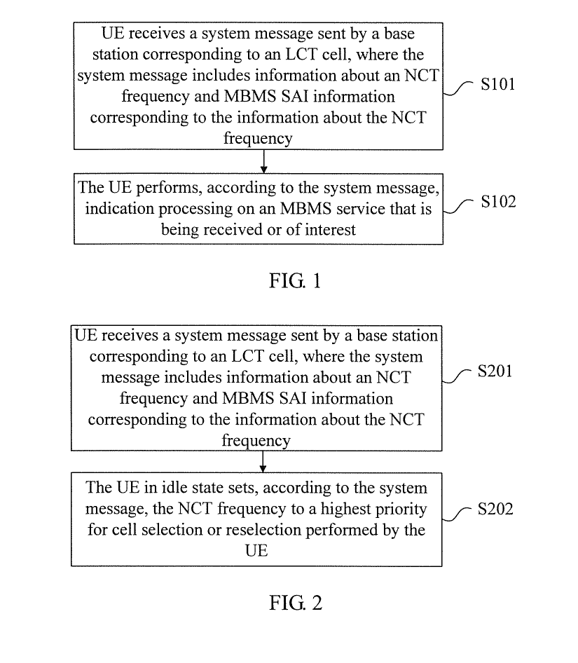

FIG. 1 is a flowchart of Embodiment 1 of a service indication processing method according to the present invention. As shown in FIG. 1, the service indication processing method in this embodiment includes:

S101. UE receives a system message sent by a base station corresponding to an LCT cell, where the system message includes information about an NCT frequency and MBMS SAI information corresponding to the information about the NCT frequency.

Specifically, the LCT cell or an LCT frequency may provide assistance for an NCT cell in supporting an MBMS service. That the LCT cell or an LCT frequency may provide assistance for an NCT cell in supporting an MBMS service may include that the NCT cell sends MBMS configuration information of the NCT cell to the UE by using the base station corresponding to the LCT cell and the base station corresponding to the LCT cell notifies the UE of the LCT cell or the LCT frequency on which the UE needs to camp for receiving an MBMS of the NCT cell. The system message in this embodiment may be a broadcast message. The information about the NCT frequency and the MBMS SAI information corresponding to the information about the NCT frequency in this embodiment may be carried in a system information block (System Information Block, SIB for short) SIB15 or a newly defined SIB of the system message. The information about the NCT frequency may be an NCT frequency or a list of NCT frequencies. The MBMS SAI information may be an MBMS SAI or an MBMS SAI list.

Optionally, the system message further includes at least one type of the following information:

identity information of an NCT cell;

an LCT frequency that provides assistance for the NCT cell or the NCT frequency in supporting the MBMS service; and

identity information of an LCT cell that provides assistance for the NCT cell or the NCT frequency in supporting the MBMS service.

The identity information of the NCT cell may include an ID of the NCT cell or an ID list of NCT cells.

Because the NCT cell or the NCT frequency cannot work independently, the NCT cell or the NCT frequency requires assistance of the LCT cell or the LCT frequency in supporting the MBMS service. The system message may further include the LCT frequency or the identity information of the LCT cell that provides assistance for the NCT cell in supporting the MBMS service, where the identity information of the LCT cell may be an ID of an LCT cell.

Optionally, resources of the NCT frequency are all used to support the MBMS and the system message may further include resource indication information or resource configuration information.

The resource indication information may be used to indicate that the resources of the NCT frequency are all used to support the MBMS, and used to indicate a manner of receiving the MBMS. The resource configuration information is used to configure the resources of the NCT frequency.

Optionally, the resource indication information may include at least one type of the following information:

an indication of supporting multiple-input multiple-output;

an indication of supporting a reference signal; and

an indication of supporting a transfer mode; and

the resource configuration information may include at least one type of the following information:

a configuration of multiple-input multiple-output;

a configuration of a reference signal; and

a configuration of a transfer mode.

S102. The UE performs, according to the system message, indication processing on an MBMS service that is being received or of interest.

Specifically, the UE may perform, according to information included in the received system message, the indication processing on the MBMS service that is being received or of interest, so that the UE or the base station determines a frequency corresponding to the MBMS service that is being received or of interest, and further, the MBMS service that is being received or of interest is preferentially received, thereby ensuring continuity of a service. For example, UE in idle state and UE in connected state may perform, according to the information included in the received system message, different indication processing on the MBMS service that is being received or of interest. If a frequency corresponding to an MBMS service that the UE is receiving or is interested in is an NCT frequency, the UE in idle state preferentially selects or reselects a cell in the NCT frequency during a cell selection or cell reselection process and the UE in connected state may send MBMS interest indication information including the NCT frequency or the list of NCT frequencies to the base station corresponding to the LCT cell, so that the UE in connected state may be handed over to a cell in the NCT frequency during a cell handover, and continuity of receiving, by the UE, the MBMS service that is being received or of interest can be ensured during cell selection or reselection and a cell handover.

According to the service indication processing method provided in this embodiment, UE receives a system message sent by a base station corresponding to an LCT cell, where the system message includes information about an NCT frequency and MBMS SAI information corresponding to the information about the NCT frequency, and the UE performs, according to the system message, indication processing on an MBMS service that is being received or of interest, so that continuity of receiving, by the UE, an MBMS service of an NCT cell can be ensured.

FIG. 2 is a flowchart of Embodiment 2 of a service indication processing method according to the present invention. As shown in FIG. 2, in the service indication processing method in this embodiment, a frequency corresponding to an MBMS service that UE is receiving or is interested in is an NCT frequency. A specific implementation manner in which the UE in idle state performs, according to a received system message, indication processing on the MBMS service that is being received or of interest is described, including:

S201. The UE receives a system message sent by a base station corresponding to an LCT cell, where the system message includes information about the NCT frequency and MBMS SAI information corresponding to the information about the NCT frequency.

For description of the system message in this embodiment, reference may be made to the embodiment shown in FIG. 1, and details are not described herein again.

S202. The UE in idle state sets, according to the system message, the NCT frequency to a highest priority for cell selection or reselection performed by the UE.

Specifically, the UE in idle state sets, to the highest priority for the cell selection or the reselection performed by the UE, a frequency corresponding to the MBMS service that is being received or of interest, so that it can be ensured that the UE in idle state preferentially selects or reselects a cell on the frequency corresponding to the MBMS service that the UE is receiving or is interested in during a cell selection or cell reselection process. The frequency corresponding to the MBMS service that is being received or of interest may be an intra-frequency LCT frequency or an inter-frequency LCT frequency, where the intra-frequency LOT frequency or the inter-frequency LCT frequency is adjacent to the LCT cell, or may be an NOT frequency. In this embodiment, the frequency corresponding to the MBMS service that the UE is receiving or is interested in is an NCT frequency. Because the LCT cell or an LCT frequency provides assistance for an NCT cell or the NCT frequency in supporting the MBMS service, in some scenarios in which the UE needs to camp on the LCT cell that provides assistance for the NCT cell or the NCT frequency in supporting the MBMS service, the following two manners may also be used in S202:

Manner 1: The UE in idle state sets, according to the system message, the LCT frequency to the highest priority for the cell selection or the reselection performed by the UE, where LCT frequency provides assistance for the NCT frequency in supporting the MBMS service.

Manner 2: The UE in idle state sets, according to the system message, the NCT frequency and the LCT frequency to the highest priority for cell selection or reselection performed by the UE, where the LOT frequency provides assistance for the NOT frequency in supporting the MBMS service.

According to a method for processing a service of an NCT cell provided in this embodiment, UE receives a system message sent by a base station corresponding to an LCT cell, where the system message includes information about an NCT frequency and MBMS SAI information corresponding to the information about the NCT frequency, and the UE in idle state sets, according to the system message, the NCT frequency to a highest priority for cell selection or reselection performed by the UE, so that continuity of receiving, by the UE in idle state, an MBMS service can be ensured.

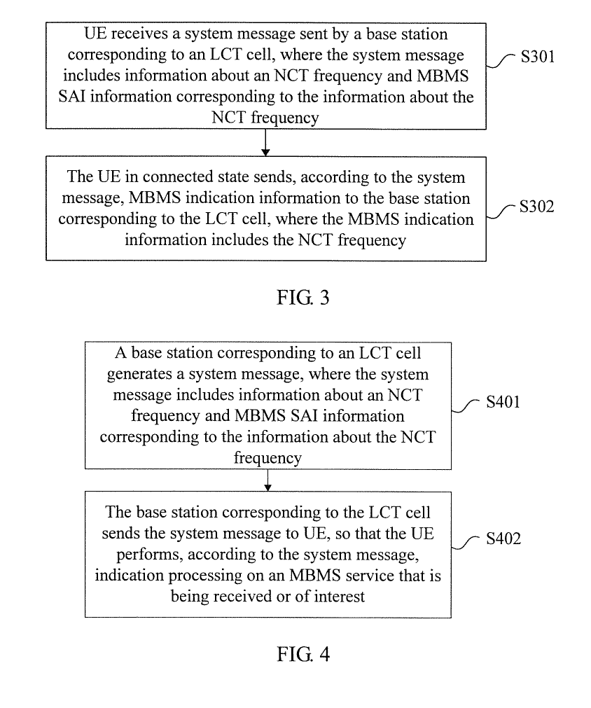

FIG. 3 is a flowchart of Embodiment 3 of a service indication processing method according to the present invention. As shown in FIG. 3, in the service indication processing method in this embodiment, a frequency corresponding to an MBMS service that UE is receiving or is interested in is an NCT frequency. A specific implementation manner in which the UE in connected state performs, according to a received system message, indication processing on the MBMS service that is being received or of interest is described, including:

S301. The UE receives a system message sent by a base station corresponding to an LCT cell, where the system message includes information about the NCT frequency and MBMS SAI information corresponding to the information about the NCT frequency.

For description of the system message in this embodiment, reference may be made to the embodiment shown in FIG. 1, and details are not described herein again.

S302. The UE in connected state sends, according to the system message, MBMS indication information to the base station corresponding to the LCT cell, where the MBMS indication information includes the NCT frequency.

Specifically, the UE in connected state may send MBMS indication information including the NCT frequency or a list of NCT frequencies to the base station corresponding to the LCT cell, so that the UE in connected state may be handed over to a cell in the NCT frequency during a cell handover, and continuity of receiving, by the UE in connected state, an MBMS service can be ensured.

According to the method for processing a service of an NCT cell provided in this embodiment, UE receives a system message sent by a base station corresponding to an LCT cell, where the system message includes information about an NCT frequency and MBMS SAI information corresponding to the information about the NOT frequency, and the UE in connected state sends, according to the system message, MBMS indication information to the base station corresponding to the LOT cell, where the MBMS indication information includes the NCT frequency, so that continuity of receiving, by the UE in connected state, an MBMS service can be ensured.

FIG. 4 is a flowchart of Embodiment 4 of a service indication processing method according to the present invention. As shown in FIG. 4, the service indication processing method in this embodiment includes:

S401. A base station corresponding to an LCT cell generates a system message, where the system message includes information about an NCT frequency and MBMS SAI information corresponding to the information about the NCT frequency.

Optionally, the system message further includes at least one type of the following information:

identity information of an NCT cell;

an LCT frequency that provides assistance for the NCT cell or the NCT frequency in supporting an MBMS service; and

identity information of an LCT cell that provides assistance for the NCT cell or the NCT frequency in supporting the MBMS service.

The identity information of the NCT cell may include an ID of the NCT cell or an ID list of NCT cells.

Because the NCT cell or the NCT frequency cannot work independently, the NCT cell or the NCT frequency requires assistance of the LCT cell or the LCT frequency in supporting the MBMS service. The system message may further include the LCT frequency or the identity information of the LCT cell, where the LCT frequency or the LOT cell provides assistance for the NCT cell in supporting the MBMS service, and the identity information of the LCT cell may be an ID of an LCT cell.

Optionally, resources of the NCT frequency are all used to support the MBMS and the system message may further include resource indication information or resource configuration information.

The resource indication information may be used to indicate that the resources of the NCT frequency are all used to support the MBMS, and used to indicate a manner of receiving the MBMS. The resource configuration information is used to configure the resources of the NCT frequency.

Optionally, the resource indication information may include at least one type of the following information:

an indication of supporting multiple-input multiple-output;

an indication of supporting a reference signal; and

an indication of supporting a transfer mode; and

the resource configuration information may include at least one type of the following information:

a configuration of multiple-input multiple-output;

a configuration of a reference signal; and

a configuration of a transfer mode.

S402. The base station corresponding to the LCT cell sends the system message to UE, so that the UE performs, according to the system message, indication processing on an MBMS service that is being received or of interest.

Specifically, the UE may perform, according to information included in the system message received from the base station corresponding to the LCT cell, indication processing on the MBMS service that is being received or of interest. UE in idle state and UE in connected state may perform, according to the information included in the received system message, different indication processing on the MBMS service that is being received or of interest. If a frequency corresponding to an MBMS service that the UE is receiving or is interested in is an NCT frequency, the UE in idle state preferentially selects or reselects a cell in the NCT frequency during a cell selection or cell reselection process and the UE in connected state may send MBMS interest indication information including the NCT frequency or a list of NCT frequencies to the base station corresponding to the LCT cell, so that the UE in connected state may be handed over to a cell in the NCT frequency during a cell handover, and continuity of receiving, by the UE, the MBMS service that is being received or of interest can be ensured during cell selection or reselection and a cell handover.

In the service indication processing method provided in this embodiment, a base station corresponding to an LCT cell generates a system message, where the system message includes information about an NCT frequency and MBMS SAI information corresponding to the information about the NCT frequency, and the base station corresponding to the LCT cell sends the system message to UE, so that the UE performs, according to the system message, indication processing on an MBMS service that is being received or of interest, and continuity of receiving, by the UE, an MBMS service of an NCT cell can be ensured.

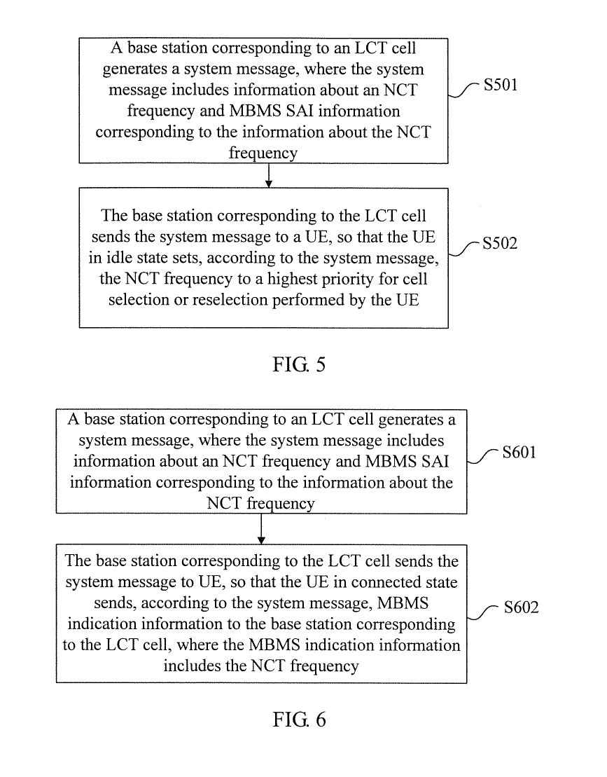

FIG. 5 is a flowchart of Embodiment 5 of a service indication processing method according to the present invention. As shown in FIG. 5, in the service indication processing method in this embodiment, a frequency corresponding to an MBMS service that UE is receiving or is interested in is an NCT frequency. A specific implementation manner in which the UE in connected state performs, according to a received system message, indication processing on the MBMS service that is being received or of interest is described, including:

S501. A base station corresponding to an LCT cell generates a system message, where the system message includes information about the NCT frequency and MBMS SAI information corresponding to the information about the NCT frequency.

For description of the system message in this embodiment, reference may be made to the embodiment shown in FIG. 4, and details are not described herein again.

S502. The base station corresponding to the LCT cell sends the system message to UE, so that the UE in idle state sets, according to the system message, the NCT frequency to a highest priority for cell selection or reselection performed by the UE.

In this embodiment, the frequency corresponding to the MBMS service that the UE is receiving or is interested in is an NCT frequency. Because the LCT cell or an LCT frequency provides assistance for an NCT cell or the NCT frequency in supporting the MBMS service, in some scenarios in which the UE needs to camp on the LCT cell that provides assistance for the NCT cell or the NCT frequency in supporting the MBMS service, the following two manners may also be used in S502:

Manner 1: The base station corresponding to the LCT cell sends the system message to the UE, so that the UE in idle state sets, according to the system message, the LCT frequency to the highest priority for cell selection or reselection performed by the UE, where the LCT frequency provides assistance for the NCT frequency in supporting the MBMS service.

Manner 2: The base station corresponding to the LOT cell sends the system message to the UE, so that the UE in idle state sets, according to the system message, the NCT frequency and the LCT frequency to the highest priority for cell selection or reselection performed by the UE, where the LCT frequency provides assistance for the NCT frequency in supporting the MBMS service.

In the method for processing a service of an NCT cell provided in this embodiment, a base station corresponding to an LCT cell generates a system message, where the system message includes information about an NCT frequency and MBMS SAI information corresponding to the information about the NCT frequency, and the base station corresponding to the LOT cell sends the system message to UE, so that the UE in idle state sets, according to the system message, the NCT frequency to a highest priority for cell selection or reselection performed by the UE, and continuity of receiving, by the UE in idle state, an MBMS service can be ensured.

FIG. 6 is a flowchart of Embodiment 6 of a service indication processing method according to the present invention. As shown in FIG. 6, in the service indication processing method in this embodiment, a frequency corresponding to an MBMS service that UE is receiving or is interested in is an NCT frequency. A specific implementation manner in which the UE in connected state performs, according to a received system message, indication processing on the MBMS service that is being received or of interest is described, including:

S601. A base station corresponding to an LCT cell generates a system message, where the system message includes information about the NCT frequency and MBMS SAI information corresponding to the information about the NCT frequency.

For description of the system message in this embodiment, reference may be made to the embodiment shown in FIG. 4, and details are not described herein again.

S602. The base station corresponding to the LOT cell sends the system message to the UE, so that the UE in connected state sends, according to the system message, MBMS indication information to the base station corresponding to the LCT cell, where the MBMS indication information includes the NCT frequency.

According to the method for processing a service of an NCT cell provided in this embodiment, a base station corresponding to an LCT cell generates a system message, where the system message includes information about an NOT frequency and MBMS SAI information corresponding to the information about the NCT frequency, and the base station corresponding to the LCT cell sends the system message to UE, so that the UE in connected state sends, according to the system message, MBMS indication information to the base station corresponding to the LCT cell, where the MBMS indication information includes the NCT frequency, and continuity of receiving, by the UE in connected state, an MBMS service can be ensured.

The following embodiment describes a counting procedure of an NCT cell in an LTE system in which an NCT cell is introduced in an access network. The NCT cell cannot work independently, for example, there is no physical downlink control channel (Physical Downlink Control Channel, PDCCH for short) in the NCT cell. This embodiment is applicable to a scenario in which an LCT cell assists the NCT cell in implementing a counting procedure.

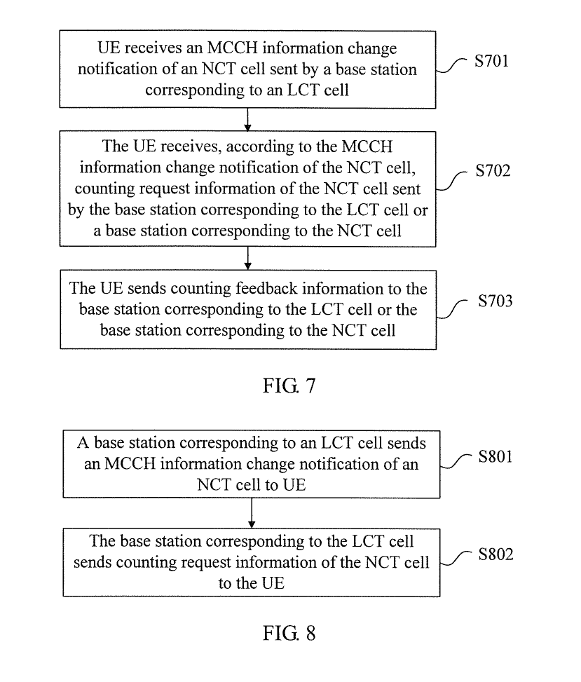

FIG. 7 is a flowchart of Embodiment 1 of a method for service counting in a new carrier type cell according to the present invention. As shown in FIG. 7, the method for service counting in a new carrier type cell in this embodiment includes:

S701. UE receives an MCCH information change notification of an NCT cell sent by a base station corresponding to an LCT cell.

Specifically, the multicast control channel (Multicast Control Channel, MCCH for short) information change notification of the NCT cell sent to the UE is used to notify the UE that the MCCH information of the NCT cell is changed, and then counting request information is sent to the UE.

S702. The UE receives, according to the MCCH information change notification of the NCT cell, counting request information of the NCT cell sent by the base station corresponding to the LCT cell or a base station corresponding to the NCT cell.

Specifically, the counting request information may be sent to the UE by the base station corresponding to the LCT cell or the base station corresponding to the NCT cell. If the counting request information is sent to the UE by the base station corresponding to the LOT cell, MBMS counting request information that is sent by a multi-cell/multicast coordination entity (Multi-Cell/Multicast Coordination Entity, MCE for short) and received by the base station corresponding to the LCT cell needs to include NCT information and area identity information of a multimedia broadcast multicast service single frequency network (Multimedia Broadcast multicast service Single Frequency Network, MBSFN for short). The NCT information may be identity information of the NCT cell or identity information of an NCT carrier frequency.

S703. The UE sends counting feedback information of the NCT cell to the base station corresponding to the LCT cell or the base station corresponding to the NCT cell.

Specifically, if the UE supports receiving of an MBMS service in the NCT cell, the UE may send the counting feedback information to the base station corresponding to the LCT cell or the base station corresponding to the NOT cell, so that the base station corresponding to the LCT cell or the base station corresponding to the NCT cell collects statistics about a feedback of the UE and reports the feedback to the MCE.

It may be understood that if the UE does not support receiving of an MBMS service in the NCT cell, the UE may do not perform S703.

In this embodiment, because there is no PDCCH in the NCT cell, the base station corresponding to the LCT cell sends the MCCH information change notification of the NCT cell, so that support of the NCT cell for an MBMS service counting procedure can be achieved.

According to the method for service counting in a new carrier type cell provided in this embodiment, UE receives an MCCH information change notification of the NCT cell sent by a base station corresponding to an LCT cell, then receives, according to the MCCH information change notification of the NCT cell, counting request information of the NCT cell sent by the base station corresponding to the LCT cell or a base station corresponding to the NCT cell, and sends counting feedback information to the base station corresponding to the LCT cell or the base station corresponding to the NCT cell, so that support of the NCT cell for an MBMS service counting procedure can be achieved and an application scenario of an MBMS is extended.

FIG. 8 is a flowchart of Embodiment 2 of a method for service counting in a new carrier type cell according to the present invention. As shown in FIG. 8, the method for service counting in a new carrier type cell in this embodiment includes:

S801. A base station corresponding to an LCT cell sends an MCCH information change notification of an NCT cell to UE.

S802. The base station corresponding to the LCT cell sends counting request information of the NCT cell to the UE.

Further, before S801, the method may further include: receiving, by the base station corresponding to the LCT cell, MBMS counting request information of the NCT cell sent by an MCE.

Optionally, the MBMS counting request information of the NCT cell may include:

temporary mobile group identity (Temporary Mobile Group Identity) TMGI information;

identity information of the NCT cell or identity information of an NCT carrier frequency; and

identity information of a multimedia broadcast multicast service single frequency network MBSFN area.

The TMGI information is used to indicate an MBMS service that needs to be reported.

Because the MCCH information change notification of the NCT cell is sent by the base station corresponding to the LCT cell, the MBMS counting request information sent by the MCE to the base station corresponding to the LCT cell needs to include:

the identity information of the NCT cell or the identity information of the NCT carrier frequency; and

the identity information of the multimedia broadcast multicast service single frequency network MBSFN area.

According to the method for service counting in a new carrier type cell provided in this embodiment, a base station corresponding to an LCT cell sends an MCCH information change notification of the NCT cell to UE, and the base station corresponding to the LCT cell sends counting request information of the NCT cell to the UE, so that support of the NCT cell for an MBMS service counting procedure can be achieved and an application scenario of an MBMS is extended.

The following describes different implementation manners of the technical solutions of the present invention by using interaction processes between UE, a base station corresponding to an LCT cell, a base station corresponding to an NCT cell, and an MCE.

It should be noted that the following embodiments are described by using an example in which an LCT cell and an NCT cell belong to different base stations. For a scenario in which an LCT cell and an NCT cell belong to a same base station, in different embodiments, information or data is sent by the same base station to UE by using different cells, that is, sent by using the LCT cell or the NCT cell. Information sent by an MCE to the same base station may include information about the LCT cell and information about the NCT cell, and an implementation principle thereof is the same with that of a scenario in which an LCT cell and an NCT cell belong to different base stations. Therefore, details are not described again.

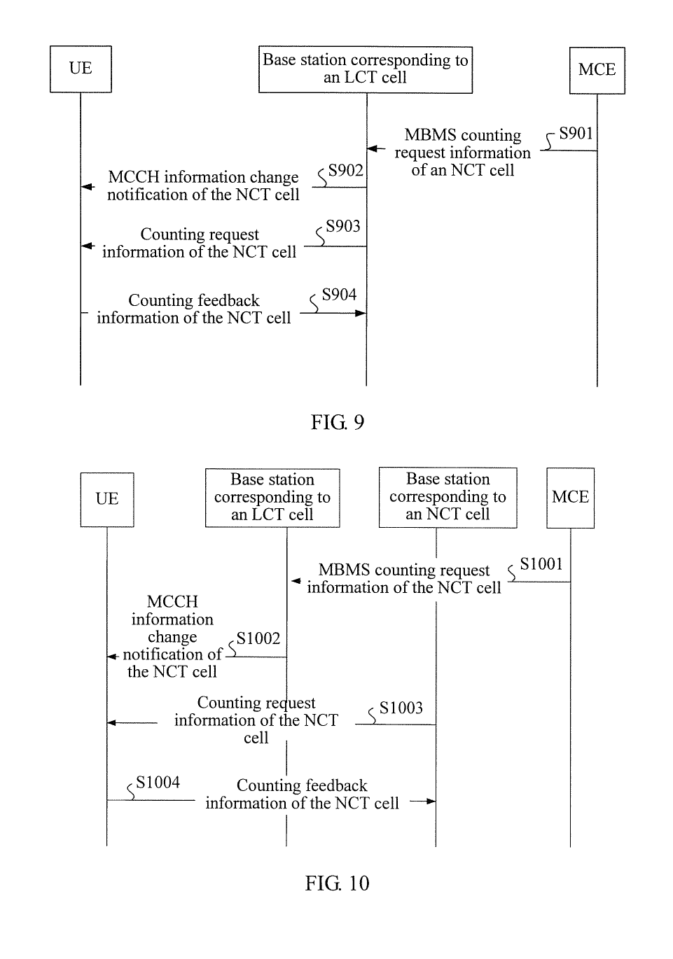

FIG. 9 is a flowchart of Embodiment 3 of a method for service counting in a new carrier type cell according to the present invention. As shown in FIG. 9, the method for service counting in a new carrier type cell in this embodiment includes:

S901. An MCE sends MBMS counting request information of an NCT cell to a base station corresponding to an LCT cell.

The MBMS counting request information in this embodiment includes: TMGI information;

identity information of the NCT cell or identity information of an NCT carrier frequency; and

identity information of a multimedia broadcast multicast service single frequency network MBSFN area.

S902. The base station corresponding to the LCT cell sends an MCCH information change notification of the NCT cell to UE.

S903. The base station corresponding to the LCT cell sends the counting request information of the NCT cell to the UE.

S904. The UE sends counting feedback information of the NCT cell to the base station corresponding to the LCT cell.

Specifically, if the UE supports receiving of an MBMS service in the NCT cell, the UE may send the counting feedback information to the base station corresponding to the LCT cell or a base station corresponding to the NCT cell, so that the base station corresponding to the LCT cell or the base station corresponding to the NCT cell collects statistics about a feedback of the UE and reports the feedback to the MCE.

It may be understood that if the UE does not support receiving of an MBMS service in the NCT cell, the UE may do not perform S904.

According to the method for service counting in a new carrier type cell provided in this embodiment, UE receives an MCCH information change notification of the NCT cell sent by a base station corresponding to an LCT cell, then receives, according to the MCCH information change notification of the NCT cell, counting request information of the NCT cell sent by the base station corresponding to the LCT cell or a base station corresponding to the NCT cell, and sends counting feedback information to the base station corresponding to the LCT cell or the base station corresponding to the NCT cell, so that support of the NCT cell for an MBMS service counting procedure can be achieved and an application scenario of an MBMS is extended.

FIG. 10 is a flowchart of Embodiment 4 of a method for service counting in a new carrier type cell according to the present invention. As shown in FIG. 10, the method for service counting in a new carrier type cell in this embodiment includes:

S1001. An MCE sends MBMS counting request information of an NCT cell to a base station corresponding to an LCT cell.

The MBMS counting request information in this embodiment includes TMGI information.

In this embodiment, because the counting request information of the NCT cell is sent by a base station corresponding to the NCT cell to UE, the MBMS counting request information of the NCT cell may do not include:

identity information of the NCT cell or identity information of an NCT carrier frequency; or

identity information of a multimedia broadcast multicast service single frequency network MBSFN area.

S1002. The base station corresponding to the LCT cell sends an MCCH information change notification of the NCT cell to UE.

S1003. Abase station corresponding to the NCT cell sends the counting request information of the NCT cell to the UE.

S1004. The UE sends counting feedback information of the NCT cell to the base station corresponding to the NCT cell.

According to the method for service counting in a new carrier type cell provided in this embodiment, a base station corresponding to an LCT cell sends an MCCH information change notification of the NCT cell to UE, and the base station corresponding to the LCT cell sends counting request information of the NCT cell to the UE, so that support of the NCT cell for an MBMS service counting procedure can be achieved and an application scenario of an MBMS is extended.

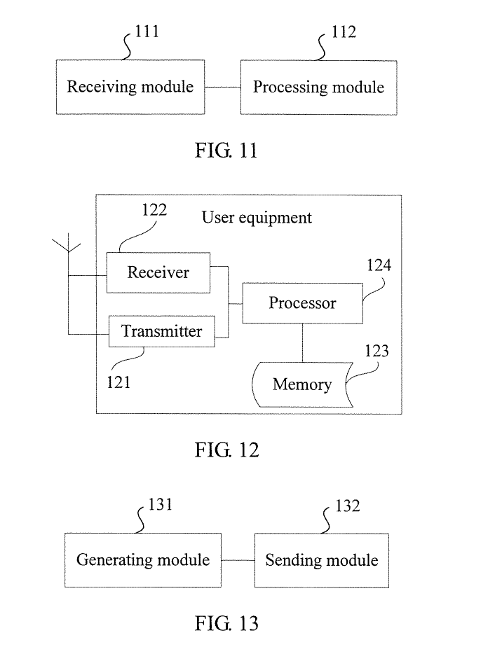

FIG. 11 is a flowchart of Embodiment 1 of user equipment according to the present invention. As shown in FIG. 11, the user equipment in this embodiment includes: a receiving module 111 and a processing module 112. The receiving module 111 is configured to receive a system message sent by a base station corresponding to an LOT cell, where the system message includes information about an NCT frequency and MBMS SAI information corresponding to the information about the NOT frequency, and the processing module 112 is configured to perform, according to the system message, indication processing on an MBMS service that is being received or of interest.

Optionally, the system message further includes at least one type of the following information:

identity information of an NCT cell;

an LCT frequency that provides assistance for the NCT cell or the NCT frequency in supporting the MBMS service; and

identity information of an LCT cell that provides assistance for the NCT cell or the NCT frequency in supporting the MBMS service.

Optionally, resources of the NCT frequency are all used to support the MBMS and the system message further includes resource indication information or resource configuration information.

Optionally, the resource indication information includes at least one type of the following information:

an indication of supporting multiple-input multiple-output;

an indication of supporting a reference signal; and

an indication of supporting a transfer mode; and

the resource configuration information includes at least one type of the following information:

a configuration of multiple-input multiple-output;

a configuration of a reference signal; and

a configuration of a transfer mode.

Further, a frequency corresponding to the MBMS service that is being received or of interest is an NCT frequency; and

the processing module 112 is specifically configured to:

set, according to the system message, the NCT frequency to a highest priority for cell selection or reselection performed by the UE; or

set, according to the system message, the LCT frequency to a highest priority for cell selection or reselection performed by the UE, where the LCT frequency provides assistance for the NCT frequency in supporting the MBMS service; or

set, according to the system message, the NCT frequency and the LCT frequency to a highest priority for cell selection or reselection performed by the UE, where the LCT frequency provides assistance for the NCT frequency in supporting the MBMS service.

Further, a frequency corresponding to the MBMS service that is being received or of interest is an NCT frequency; and

the processing module 112 is specifically configured to:

send, according to the system message, MBMS indication information to the base station corresponding to the LCT cell, where the MBMS indication information includes the NCT frequency.

The apparatus in this embodiment may be configured to implement the technical solutions in the method embodiments shown in FIG. 1, FIG. 2 and FIG. 3, and implementation principles and technical effects of the apparatus are similar to those of the method embodiments shown in FIG. 1, FIG. 2 and FIG. 3. Details are not described herein again.

FIG. 12 is a schematic structural diagram of Embodiment 2 of user equipment according to the present invention. As shown in FIG. 12, the user equipment in this embodiment includes a transmitter 121, a receiver 122, a memory 123, and a processor 124 that is separately connected to the transmitter 121, the receiver 122, and the memory 123. Certainly, the user equipment in this embodiment may further include general components, such as an antenna, a baseband processing component, a medium radio frequency processing component, and an input and output apparatus, and this embodiment of the present invention imposes no limitation on this.

A set of program code is stored in the memory 123, and the processor 124 is configured to invoke the program code stored in the memory 123 to execute the following operations:

receiving a system message sent by a base station corresponding to an LCT cell, where the system message includes information about an NCT frequency and MBMS SAI information corresponding to the information about the NCT frequency; and

performing, according to the system message, indication processing on an MBMS service that is being received or of interest.

FIG. 13 is a schematic structural diagram of Embodiment 1 of a base station corresponding to a legacy carrier type according to the present invention. As shown in FIG. 13, the base station corresponding to the legacy carrier type in this embodiment includes: a generating module 131 and a sending module 132. The generating module 131 is configured to generate a system message, where the system message includes information about an NCT frequency and MBMS SAI information corresponding to the information about the NCT frequency. The sending module 132 is configured to send the system message to UE, so that the UE performs, according to the system message, indication processing on an MBMS service that is being received or of interest.

Optionally, the system message further includes at least one type of the following information:

identity information of an NCT cell;

an LCT frequency that provides assistance for the NCT cell or the NCT frequency in supporting the MBMS service; and

identity information of an LCT cell that provides assistance for the NCT cell or the NCT frequency in supporting the MBMS service.

Optionally, resources of the NCT frequency are all used to support the MBMS and the system message further includes resource indication information or resource configuration information.

Optionally, the resource indication information includes at least one type of the following information:

an indication of supporting multiple-input multiple-output;

an indication of supporting a reference signal; and

an indication of supporting a transfer mode; and

the resource configuration information includes at least one type of the following information:

a configuration of multiple-input multiple-output;

a configuration of a reference signal; and

a configuration of a transfer mode.

Further, a frequency corresponding to the MBMS service that is being received or of interest is an NCT frequency; and

the sending module 132 is specifically configured to:

send the system message to the UE, so that the UE in idle state sets, according to the system message, the NCT frequency to a highest priority for cell selection or reselection performed by the UE; or

send the system message to the UE, so that the UE in idle state sets, according to the system message, the LCT frequency to a highest priority for cell selection or reselection performed by the UE, where the LCT frequency provides assistance for the NCT frequency in supporting the MBMS service; or

send the system message to the UE, so that the UE in idle state sets, according to the system message, the NCT frequency and the LCT frequency to a highest priority for cell selection or reselection performed by the UE, where the LCT frequency provides assistance for the NCT frequency in supporting the MBMS service.

Further, a frequency corresponding to the MBMS service that is being received or of interest is an NCT frequency; and

the sending module 132 is specifically configured to:

send the system message to the UE, so that the UE in connected state sends, according to the system message, MBMS indication information to the base station corresponding to the LCT cell, where the MBMS indication information includes the NCT frequency.

The apparatus in this embodiment may be configured to implement the technical solutions in the method embodiments shown in FIG. 4, FIG. 5 and FIG. 6, and implementation principles and technical effects of the apparatus are similar to those of the method embodiments shown in FIG. 1, FIG. 2 and FIG. 3. Details are not described herein again.

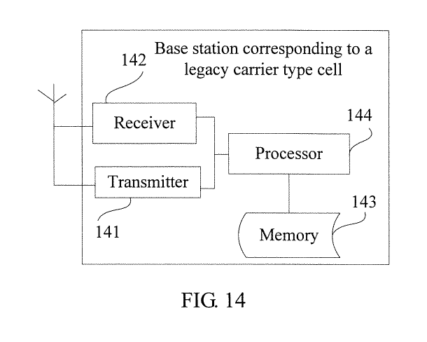

FIG. 14 is a schematic structural diagram of Embodiment 2 of abase station corresponding to a legacy carrier type cell according to the present invention. As shown in FIG. 14, the base station corresponding to the legacy carrier type cell in this embodiment includes a transmitter 141, a receiver 142, a memory 143, and a processor 144 that is separately connected to the transmitter 141, the receiver 142, and the memory 143. Certainly, the base station corresponding to the legacy carrier type cell in this embodiment may further include general components, such as an antenna, a baseband processing component, a medium radio frequency processing component, and an input and output apparatus, and this embodiment of the present invention imposes no limitation on this.

A set of program code is stored in the memory 143, and the processor 144 is configured to invoke the program code stored in the memory 143 to execute the following operations:

generating a system message, where the system message includes information about an NCT frequency and MBMS SAI information corresponding to the information about the NCT frequency; and

sending the system message to UE, so that the UE performs, according to the system message, indication processing on an MBMS service that is being received or of interest.

In the several embodiments provided in the present invention, it should be understood that the disclosed apparatus and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present invention may be integrated into one processing unit, or each of the units may exist alone physically, or two or more units are integrated into one unit. The integrated unit may be implemented in a form of hardware, or may be implemented in a form of hardware in addition to a software functional unit.

When the foregoing integrated unit is implemented in a form of a software functional unit, the integrated unit may be stored in a computer-readable storage medium. The software functional unit is stored in a storage medium and includes several instructions for instructing a computer device (which may be a personal computer, a server, or a network device) or a processor (processor) to perform some of the steps of the methods described in the embodiments of the present invention. The foregoing storage medium includes: any medium that can store program code, such as an USB flash drive, a removable hard disk, a read-only memory (Read-Only Memory, ROM), a random access memory (Random Access Memory, RAM), a magnetic disk, or an optical disc.

It may be clearly understood by a person skilled in the art that, for the purpose of convenient and brief description, division of the foregoing functional modules is taken as an example for illustration. In actual application, the foregoing functions can be allocated to different functional modules and implemented according to a requirement, that is, an inner structure of an apparatus is divided into different functional modules to implement all or some of the functions described above. For a detailed working process of the foregoing apparatus, refer to a corresponding process in the foregoing method embodiments, and details are not described herein again.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present invention.

What is claimed is:

1. A service indication processing method, comprising:
receiving, by user equipment (UE), a system message sent by abase station corresponding to a legacy carrier type (LCT) cell, wherein the system message comprises information about a new carrier type (NCT) frequency and information about a service area identity (SAI) of a multimedia broadcast multicast service (MBMS) and corresponds to the information about the NCT frequency; and
performing, by the UE according to the system message, indication processing on an MBMS being received or of interest.

2. The method according to claim 1, wherein the system message further comprises at least one type of the following information:
identity information of an NCT cell;
an LCT frequency that provides assistance for the NCT cell or the NCT frequency in supporting the MBMS; and
identity information of an LCT cell that provides assistance for the NCT cell or the NCT frequency in supporting the MBMS.

3. The method according to claim 1, wherein resources of the NCT frequency are all used to support the MBMS, and the system message further comprises resource indication information or resource configuration information.

4. The method according to claim 3, wherein:
the resource indication information comprises at least one type of the following information:
an indication of supporting multiple-input multiple-output,
an indication of supporting a reference signal, and
an indication of supporting a transfer mode; and
the resource configuration information comprises at least one type of the following information:
a configuration of multiple-input multiple-output,
a configuration of a reference signal, and
a configuration of a transfer mode.

5. The method according to claim 1, wherein:
a frequency corresponding to the MBMS being received or of interest is an NCT frequency; and
performing, by the UE according to the system message, indication processing on an MBMS being received or of interest comprises:
setting, by the UE in idle state according to the system message, the NCT frequency to a highest priority for cell selection or reselection performed by the UE, or
setting, by the UE in idle state according to the system message, the LCT frequency to a highest priority for cell selection or reselection performed by the UE, wherein the LCT frequency provides assistance for the NCT frequency in supporting the MBMS, or
setting, by the UE in idle state according to the system message, the NCT frequency and the LCT frequency to a highest priority for cell selection or reselection performed by the UE, wherein the LCT frequency provides assistance for the NCT frequency in supporting the MBMS service.

6. The method according to claim 1, wherein:
a frequency corresponding to the MBMS being received or of interest is an NCT frequency; and
performing, by the UE according to the system message, indication processing on an MBMS being received or of interest comprises:
sending, by the UE in connected state according to the system message, MBMS indication information to the base station corresponding to the LCT cell, wherein the MBMS indication information comprises the NCT frequency.

7. A service indication processing method, comprising:
generating, by a base station corresponding to a legacy carrier type (LCT) cell, a system message comprising information about a new carrier type (NCT) frequency and information about a service area identity (SAI) of a multimedia broadcast multicast service (MBMS) and corresponds to the information about the NCT frequency; and
sending, by the base station corresponding to the LCT cell, the system message to user equipment (UE), so that the UE performs, according to the system message, indication processing on an MBMS being received or of interest.

8. The method according to claim 7, wherein the system message further comprises at least one type of the following information:
identity information of an NCT cell;
an LCT frequency that provides assistance for the NCT cell or the NCT frequency in supporting the MBMS; and
identity information of an LCT cell that provides assistance for the NCT cell or the NCT frequency in supporting the MBMS.

9. The method according to claim 7, wherein resources of the NCT frequency are all used to support the MBMS, and the system message further comprises resource indication information or resource configuration information.

10. The method according to claim 9, wherein:
the resource indication information comprises at least one type of the following information:
an indication of supporting multiple-input multiple-output,
an indication of supporting a reference signal, and
an indication of supporting a transfer mode; and
the resource configuration information comprises at least one type of the following information:
a configuration of multiple-input multiple-output,
a configuration of a reference signal, and
a configuration of a transfer mode.

11. The method according to claim 7, wherein:
a frequency corresponding to the MBMS being received or of interest is an NCT frequency; and
sending, by the base station corresponding to the LCT cell, the system message to user equipment (UE), so that the UE performs, according to the system message, indication processing on an MBMS being received or of interest comprises:
sending, by the base station corresponding to the LCT cell, the system message to the UE, so that the UE in idle state sets, according to the system message, the NCT frequency to a highest priority for cell selection or reselection performed by the UE, or
sending, by the base station corresponding to the LCT cell, the system message to the UE, so that the UE in idle state sets, according to the system message, the LCT frequency to a highest priority for cell selection or reselection performed by the UE, wherein the LCT frequency provides assistance for the NCT frequency in supporting the MBMS, or
sending, by the base station corresponding to the LCT cell, the system message to the UE, so that the UE in idle state sets, according to the system message, the NCT frequency and the LCT frequency to a highest priority for cell selection or reselection performed by the UE, wherein the LCT frequency provides assistance for the NCT frequency in supporting the MBMS.

12. The method according to claim 7, wherein:
a frequency corresponding to the MBMS being received or of interest is an NCT frequency; and
sending, by the base station corresponding to the LCT cell, the system message to the UE, so that the UE performs, according to the system message, indication processing on an MBMS being received or of interest comprises:
sending, by the base station corresponding to the LCT cell, the system message to the UE, so that the UE in connected state sends, according to the system message, MBMS indication information to the base station corresponding to the LCT cell, wherein the MBMS indication information comprises the NCT frequency.

13. User equipment (UE), comprising:
a receiving module, configured to receive a system message sent by a base station corresponding to a legacy carrier type (LCT) cell, wherein the system message comprises information about a new carrier type (NCT) frequency and information about a service area identity (SAI) of a multimedia broadcast multicast service (MBMS) and corresponds to the information about the NCT frequency; and
a processing module, configured to perform, according to the system message, indication processing on an MBMS being received or of interest.

14. The user equipment according to claim 13, wherein the system message further comprises at least one type of the following information:
identity information of an NCT cell;
an LCT frequency that provides assistance for the NCT cell or the NCT frequency in supporting the MBMS; and
identity information of an LCT cell that provides assistance for the NCT cell or the NCT frequency in supporting the MBMS.

15. The user equipment according to claim 13, wherein resources of the NCT frequency are all used to support the MBMS and the system message further comprises resource indication information or resource configuration information.

16. The user equipment according to claim 15, wherein:
the resource indication information comprises at least one type of the following information:
an indication of supporting multiple-input multiple-output,
an indication of supporting a reference signal, and
an indication of supporting a transfer mode; and
the resource configuration information comprises at least one type of the following information:
a configuration of multiple-input multiple-output,
a configuration of a reference signal, and
a configuration of a transfer mode.

17. The user equipment according to claim 13, wherein:
a frequency corresponding to the MBMS being received or of interest is an NCT frequency; and
the processing module is configured to:
set, according to the system message, the NCT frequency to a highest priority for cell selection or reselection performed by the UE, or
set, according to the system message, the LCT frequency to a highest priority for cell selection or reselection performed by the UE, wherein the LCT frequency provides assistance for the NCT frequency in supporting the MBMS, or
set, according to the system message, the NCT frequency and the LCT frequency to a highest priority for cell selection or reselection performed by the UE, wherein the LCT frequency provides assistance for the NCT frequency in supporting the MBMS.

18. The user equipment according to claim 13, wherein:
a frequency corresponding to the MBMS being received or of interest is an NCT frequency; and
the processing module is configured to:
send, according to the system message, MBMS indication information to the base station corresponding to the LCT cell, wherein the MBMS indication information comprises the NCT frequency.

19. Abase station corresponding to a legacy carrier type (LCT), the base station comprising:
a generating module, configured to generate a system message, wherein the system message comprises information about a new carrier type (NCT) frequency and information about a service area identity (SAI) of a multimedia broadcast multicast service (MBMS) and corresponds to the information about the NCT frequency; and
a sending module, configured to send the system message to user equipment (UE), so that the UE performs, according to the system message, indication processing on an MBMS being received or of interest.

20. The base station according to claim 19, wherein the system message further comprises at least one type of the following information:
identity information of an NCT cell;
an LCT frequency that provides assistance for the NCT cell or the NCT frequency in supporting the MBMS; and
identity information of an LCT cell that provides assistance for the NCT cell or the NCT frequency in supporting the MBMS.

21. The base station according to claim 19, wherein resources of the NCT frequency are all used to support the MBMS, and the system message further comprises resource indication information or resource configuration information.

22. The base station according to claim 21, wherein:
the resource indication information comprises at least one type of the following information:
an indication of supporting multiple-input multiple-output,
an indication of supporting a reference signal, and
an indication of supporting a transfer mode; and
the resource configuration information comprises at least one type of the following information:
a configuration of multiple-input multiple-output,
a configuration of a reference signal, and
a configuration of a transfer mode.

23. The base station according to claim 19, wherein:
a frequency corresponding to the MBMS being received or of interest is an NCT frequency; and
the sending module is configured to:
send the system message to the UE, so that the UE in idle state sets, according to the system message, the NCT frequency to a highest priority for cell selection or reselection performed by the UE, or
send the system message to the UE, so that the UE in idle state sets, according to the system message, the LCT frequency to a highest priority for cell selection or reselection performed by the UE, wherein the LCT frequency provides assistance for the NCT frequency in supporting the MBMS, or
send the system message to the UE, so that the UE in idle state sets, according to the system message, the NCT frequency and the LCT frequency to a highest priority for cell selection or reselection performed by the UE, wherein the LCT frequency provides assistance for the NCT frequency in supporting the MBMS.

24. The base station according to claim 19, wherein:
a frequency corresponding to the MBMS being received or of interest is an NCT frequency; and
the sending module is configured to:
send the system message to the UE, so that the UE in connected state sends, according to the system message, MBMS indication information to the base station corresponding to the LCT cell, wherein the MBMS indication information comprises the NCT frequency.

25. User equipment (UE), comprising:
a transmitter;
a receiver;
a memory; and
a processor coupled to the transmitter, the receiver and the memory, wherein a set of program code is stored in the memory, and the processor is configured to invoke the program code stored in the memory and configure the UE to:
receive, by the UE, a system message sent by a base station corresponding to a legacy carrier type (LCT) cell, wherein the system message comprises information about a new carrier type (NCT) frequency and information about a service area identity (SAI) of a multimedia broadcast multicast service (MBMS) and corresponds to the information about the NCT frequency, and
perform, by the UE according to the system message, indication processing on an MBMS being received or of interest.

26. A base station corresponding to a legacy carrier type (LCT) cell, the base station comprising:
a transmitter;
a receiver;
a memory; and
a processor coupled to the transmitter, the receiver and the memory, wherein a set of program code is stored in the memory, and the processor is configured to invoke the program code stored in the memory and configure base station to:
generate, by the base station, a system message comprising information about a new carrier type (NCT) frequency and information about a service area identity (SAI) of a multimedia broadcast multicast service (MBMS) and corresponds to the information about the NCT frequency, and
send, by the base station, the system message to user equipment (UE), so that the UE performs, according to the system message, indication processing on an MBMS being received or of interest.
